(19) United States
(12) Patent Application Publication
(10) Pub. No.: US 2017/0338678 A1
(43) Pub. Date: Nov. 23, 2017

(54) VEHICLE ELECTRICAL POWER SYSTEM FOR JUMPSTARTING

(71) Applicant: Hyundai Motor Company, Seoul (KR)

(72) Inventors: Hee Tae YANG, Seoul (KR); Kyung In MIN, Seongnam-si (KR); Jae Hoon CHOI, Gunpo-si (KR); Kyung Ho KIM, Ansan-si (KR); Yu Seok KIM, Seoul (KR); Hyo Sik MOON, Hwaseong-si (KR); Suk Hyung KIM, Gunpo-si (KR)

(73) Assignee: Hyundai Motor Company, Seoul (KR)

(21) Appl. No.: 15/290,464

(22) Filed: Oct. 11, 2016

(30) Foreign Application Priority Data
May 20, 2016 (KR) 10-2016-0062169

(51) Int. Cl. H02J 7/00; B60L 11/18

(52) U.S. Cl. CPC H02J 7/0054; B60L 11/1816; H02J 7/0068

(57) ABSTRACT

A vehicle electric power system for jumpstarting includes: an auxiliary battery; a first relay having a first end connected to the auxiliary battery; a power connecting terminal for jumpstarting being connected to an external power source when jumpstarting is initiated; a second relay having a first end connected to the power connecting terminal and a second end electrically connected to a second end of the first relay; and a reconnection switch having a first end connected both to the auxiliary battery and to the power connecting terminal and a second end connected to a control terminal used to turn on the first relay. The reconnection switch electrically connects the first and second ends thereof to each other in response to a reconnecting input signal, thereby applying external power to the control terminal, and turning on the first relay.

### CROSS REFERENCE TO RELATED APPLICATION

The present application claims the benefit of priority to Korean Patent Application No. 10-2016-0062169, filed on May 20, 2016 with the Korean Intellectual Property Office, the entirety of which is incorporated herein for all purposes by this reference.

### TECHNICAL FIELD

The present disclosure generally relates to a vehicle electrical power system for jumpstarting. More particularly, the present disclosure relates to a vehicle electrical power system for jumpstarting in which a relay is turned on as needed when jumpstarting is initiated, the relay is connected between an auxiliary battery and a vehicle system, and the relay is turned off when a voltage of the auxiliary battery is less than or equal to a threshold value.

### BACKGROUND

Eco-friendly electrical vehicles or fuel cell vehicles generally include an auxiliary battery (referred to as a “low voltage battery”) to provide power for starting the vehicle and to provide low voltage power for devices operated at a low voltage.

When the auxiliary battery is a lithium battery, however, complete discharge of the battery should be avoided. Thus, a relay may be used to block the connection between the auxiliary battery and a vehicle system when the auxiliary battery charging state is less than or equal to a threshold voltage. In order to restart the vehicle in which the auxiliary battery is electrically blocked by the relay, the relay is manually turned on to electrically connect the auxiliary battery and the vehicle system. However, when the auxiliary battery is discharged and is not capable of restarting the vehicle system, a jumpstarting process that starts the vehicle by using external power is required.

Conventionally, a separate power connecting terminal for jumpstarting is provided and the separate power connecting terminal is connected to a low voltage system of the vehicle, whereby the vehicle system is started by providing power to the low voltage system of the vehicle by using the separate power connecting terminal for jumpstarting.

The relay that connects the auxiliary battery and the vehicle system is turned on by the power of the auxiliary battery when the voltage of the auxiliary battery is less than than a voltage required for turning on the relay, however, and thus it is impossible to turn on the relay. Therefore, a problem that the auxiliary battery cannot be recharged occurs.

The foregoing is intended merely to aid in the understanding of the background of the present disclosure, and is not intended to mean that the present disclosure falls within the purview of the related art that is already known to those skilled in the art.

### SUMMARY

In order to achieve the above object, according to one aspect of the present disclosure, there is provided a vehicle electric power system for jumpstarting in which a relay is turned on when jumpstarting is initiated, the relay connected between an auxiliary battery and a vehicle system and the relay is turned off when a voltage of the auxiliary battery is less than or equal to a threshold value, and the relay is turned on even when the voltage of the auxiliary battery is less than a voltage required to turn on the relay.

In order to achieve the above object, according to one aspect of the present disclosure, a vehicle electric power system for jumpstarting includes: an auxiliary battery; a first relay having a first end connected to the auxiliary battery; a power connecting terminal for jumpstarting, the power connecting terminal being connected to an external power source when jumpstarting is initiated; a second relay having a first end connected to the power connecting terminal and a second end electrically connected to a second end of the first relay, and a reconnection switch having a first end connected both to the auxiliary battery and to the power connecting terminal and a second end connected to a control terminal used to turn on the first relay. The reconnection switch may electrically connect the first and second ends thereof to each other in response to a reconnecting input signal, thereby applying external power received by the power connecting terminal to the control terminal, and turning on the first relay.

In one embodiment, the system may further include: a controller for monitoring a voltage of the auxiliary battery, turning off the first relay, and turning on the second relay when the voltage of the auxiliary battery is ales than or equal to a threshold value.

In one embodiment, the controller may include a power terminal electrically connected to the second end of the second relay, and the external power received by the power connecting terminal may be input to the power terminal when the second relay is turned on.

In one embodiment, the controller may monitor an electric state of the second end of the reconnection switch, and determine that the reconnecting input signal to turn on the first relay is received when an electrical signal is applied to the second end of the reconnection switch.

In one embodiment, the controller may output a warning signal when the reconnecting input signal to turn on the first relay is maintained for a threshold time period or more.

In one embodiment, the system may further include: a junction box forming an electric connection between the second end of the first relay, the second end of the second relay, and the power terminal of the controller.

In one embodiment, when the reconnecting input signal may be applied to the reconnection switch in a state in which the second relay is turned on and the external power is be applied to the power connecting terminal, the first relay may be turned on and the auxiliary battery may be charged with the external power.

According to a vehicle electric power system for jumpstarting system, the having a means for solving the problems described above may reconnect (turn on) at any time the relay that mutually blocks the auxiliary battery and the vehicle system, when jumpstarting is initiated. In particular, although the auxiliary battery may be in an over-discharged state whereby it is unable to provide enough voltage to turn on the relay, the relay may be turned on by using the external power provided for jumpstarting.

Also, according to the vehicle electric power system for jumpstarting, the system is capable of charging an auxiliary battery by using external power, and over-charging of the auxiliary battery is prevented by monitoring the voltage of the auxiliary battery via a controller.

Also, according to the vehicle electric power system for jumpstarting, when the reconnection switch is maintained in an ON state, the reconnection switch is used to turn on the relay that connects/blocks the auxiliary battery to the vehicle system, whereby the state of the reconnection switch is detected and a warning signal is output. Thus, unnecessary energy consumption and relay damage may be prevented.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is a block diagram of a vehicle electrical power system for jumpstarting according to an exemplary embodiment in the present disclosure; and

FIG. 2 is a flow chart explaining an operation of the vehicle electrical power system for jumpstarting according to an exemplary embodiment in the present disclosure.

### DETAILED DESCRIPTION OF THE EMBODIMENTS

Hereinbelow, exemplary embodiments in the present disclosure will be described in detail with reference to the accompanying drawings.

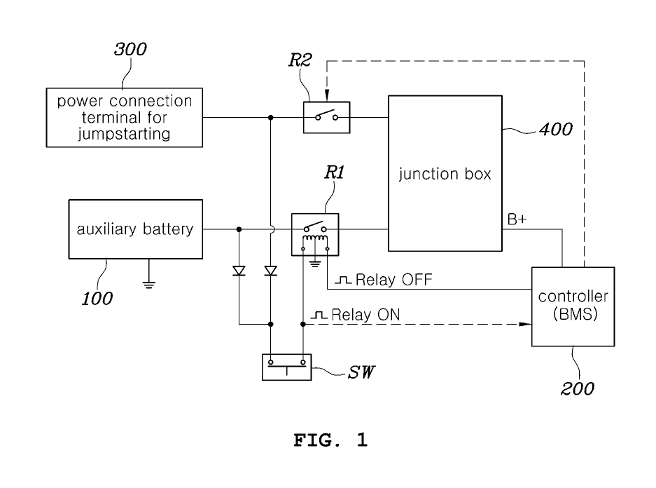

FIG. 1 is a block diagram of a vehicle electrical power system for jumpstarting according to an exemplary embodiment in the present disclosure.

Referring to FIG. 1, a vehicle electrical power system for jumpstarting according to an exemplary embodiment includes an auxiliary battery 100, a first relay R1, a power connecting terminal for jumpstarting 300, a second relay R2, and a reconnection switch SW. In addition, the vehicle electrical power system for jumpstarting according to the present exemplary embodiment may further include a controller 200 and a junction box 400.

The auxiliary battery 100 is an element that stores electrical energy and outputs low voltage (for example, about 12 V) power. The auxiliary battery 100 may provide electric power required for starting a vehicle. In some cases, the electric power may be used to supply low voltage power for devices during the vehicle operation.

A lithium battery or a lead-acid battery may be used as the auxiliary battery 100. Currently, a lead-acid battery is generally used as an auxiliary battery 100 due to the low price thereof. However, lithium batteries are expected to replace lead-acid batteries since lithium batteries have high reliability and a long lifespan. However, when a lithium battery is discharged below a certain voltage, the performance of the battery rapidly degrades. Thus, a relay R1 is required to block a connection between the battery and the vehicle system when the voltage is reduced below a certain level.

One exemplary embodiment in the present disclosure relates to a vehicle electrical power system for jumpstarting that starts the vehicle system by using external power when the auxiliary battery 100 (in particular, a lithium battery) is in a discharged state (a state where the auxiliary battery 100 is unable to provide the required voltage for starting the vehicle).

The first relay R1 is an element connecting or blocking an electrical connection between the auxiliary battery 100 (in particular, a lithium battery) and the vehicle system. When the auxiliary battery 100 is normally operated, the first relay R1 is controlled to be in a connected state, in other words, an ON state. When the voltage of the auxiliary battery 100 is at a threshold value or less, the first relay R1 is controlled to be in a blocked state, that is, an OFF state.

A first end of the first relay R1 may be connected to the auxiliary battery 100, and a second end of the first relay R1 may be connected to the vehicle system.

The first relay R1 includes a control unit that is used to receive an input signal used to control the state of the first relay R1, whereby the state of the first relay R1 may be controlled as ON/OFF in response to the input signal. In particular, one of the control units of the first relay R1 may receive an input signal to turn on the first relay, and the other control unit may receive an input signal to turn off the first relay R1.

One exemplary embodiment in the present disclosure includes a power connecting terminal for jumpstarting 300 being connected to an external power source. The power connecting terminal for jumpstarting 300 may be electrically connected to or blocked from the vehicle system by the second relay R2.

The second relay R2 is an element used to connect the power connecting terminal for jumpstarting 300 and the vehicle system when the vehicle system needs external power. Connection states of the second relay R2 may be determined by the controller 200.

A first end of the second relay R2 may be connected to the power connecting terminal for jumpstarting 300, and a second end of the second relay R2 may be connected to the vehicle system. The second end of the second relay R2 may be electrically connected to a second end of the first relay and to the controller 200 through the junction box 400.

The reconnection switch SW is an element used to apply a signal to turn on the first relay R1 when the first relay R1 is turned off. The reconnection switch SW may include first and second ends that are connected or disconnected to each other according to an external input signal. The first end of the reconnection switch SW is connected to the power connecting terminal for jumpstarting 300, and the second end of the reconnection switch SW may be connected to a control unit of the first relay R1 that receives a turn-on signal.

The controller 200 monitors the voltage of the auxiliary battery 100, and turns off the first relay R1 when the voltage of the auxiliary battery 100 is equal to or lower than a threshold value, and turns on the second relay R2. The controller 200 may be configured as a controller of a Battery Management System (BMS) that controls the auxiliary battery 100.

Also, the controller 200 may include a power terminal that is electrically connected to both the second end of the first relay R1 and the second end of the relay R2 to receive power, thereby receiving electric power.

In addition, the controller 200 monitors an electric state of the control unit of the first relay R1 that receives the input turn-on signal. The controller 200 determines that the input turn-on signal to turn on the first relay R1 is received when the electrical signal is applied to the second end of the reconnection switch SW.

The junction box 400 is an element to electrically interconnect elements related to a low-voltage operation of the vehicle power system. The junction box 400 includes multiple terminals and they may be electrically interconnected to each other. Therefore, multiple devices connected to the junction box 400 may be electrically interconnected to each other.

As shown in FIG. 1, the junction box 400 may be connected to the second end of the first relay R1, the second end of the second relay R2, and a power terminal B+ of the controller 200. Also, the junction box 400 may be connected to an output terminal of a low voltage DC-DC converter (not shown). The low voltage DC-DC converter converts high voltage of a main battery (high voltage battery) to low voltage.

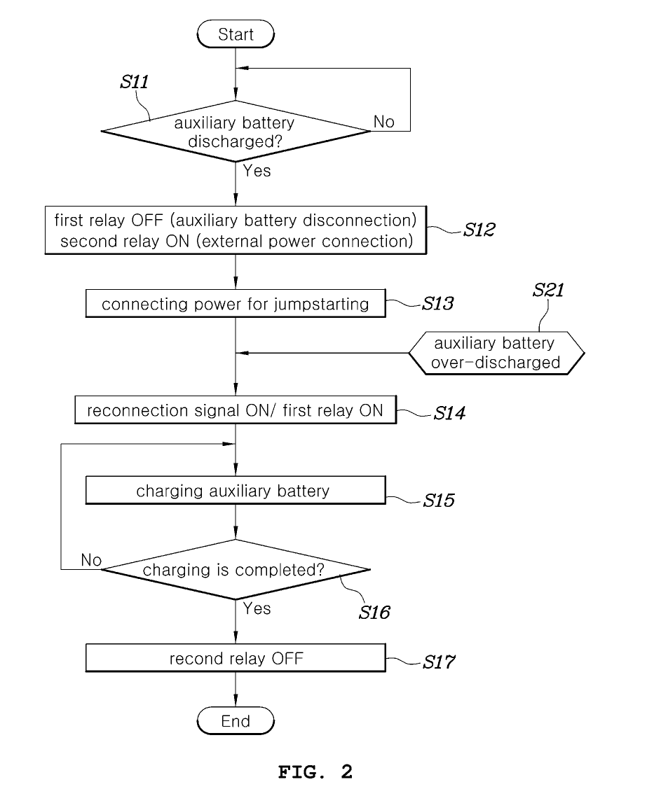

FIG. 2 is a flow chart explaining an operation of the vehicle electrical power system for jumpstarting according to an exemplary embodiment in the present disclosure.

First, at step S11, the controller 200 monitors an output voltage of the auxiliary battery 100 and determines whether the auxiliary battery 100 is discharged. For example, at step S11, the output voltage of the auxiliary battery 100 is monitored by the controller 200, and the controller 200 determines a voltage amount detected by a voltage sensor (not shown) installed on an output terminal of the auxiliary battery 100. The controller 200 may be understood as a concept including a controller that configures a Battery Management System (BMS) since the controller 200 includes a function of monitoring the voltage of the auxiliary battery 100.

Next, at step S12, when the controller 200 determines that the auxiliary battery 100 is in a discharged state, the controller 200 electrically blocks the connection between the auxiliary battery 100 and the junction box 400 by turning off the first relay R1. In other words, the auxiliary battery 100 is electrically disconnected from the vehicle system. At the same time, the controller 200 electrically connects the power connecting terminal for jumpstarting 300 to the junction box 400 by turning on the second relay R2. In other words, the power connecting terminal for jumpstarting 300 is electrically connected to the junction box 400.

At step S12, the controller 200 may be connected to the control unit of the first relay R1 that receives the turn-on signal, directly provides a control signal to the control unit, and turns off the first relay R1.

Next, at step S13, a jumpstarting is performed by an external power by connecting the external power to the power connecting terminal for jumpstarting 300. The external power connected to the power connecting terminal for jumpstarting 300 is provided to the power terminal of the controller 200 by passing the junction box 400. Thus, the controller 200 is able to perform a normal control operation.

Therefore, as described in steps S11 and S12, it may be preferred that the first relay R1 is in a turned-off state at the moment the external power is connected to the power connecting terminal for jumpstarting 300. This is because, if the first relay R1 is turned on, at the time the external power is connected to the power connecting terminal for jumpstarting 300, an overcurrent may instantaneously flow into the auxiliary battery 100, and the auxiliary battery 100 and the first relay R1 may be damaged. Also, considering the external power (for example, battery of another vehicle) connected to the power connecting terminal for jumpstarting 300, the overcurrent flowing into the auxiliary battery 100 may cause malfunction or failure to the external power or other devices (for example, vehicle) including the external power device.

Then, when the both ends of reconnection switch SW are electrically connected to each other in response to the input signal, the power connecting terminal for jumpstarting 300 and the control unit to turn on the first relay R1 are electrically connected. Since external power is being provided to the power connecting terminal for jumpstarting 300, the external voltage is applied to the control unit to turn on the first relay R1. Thus, the first relay R1 is turned on according to the applied voltage.

Conventionally, the first relay R1 is reconnected by the auxiliary battery 100. When the auxiliary battery 100 is in an over-discharged state and is unable to provide enough voltage to control the first relay R1, the auxiliary battery 100 cannot turn on the first relay R1. However, in an exemplary embodiment in the present disclosure, the power connecting terminal for jumpstarting 300 and the control unit to turn on the first relay R1 are electrically connected by the reconnection switch SW. Although the auxiliary battery 100 is in an over-discharged state, the first relay R1 may be turned on, and the auxiliary battery 100 and the vehicle system are electrically connected.

Then, since the first relay R1 is turned on, electric energy provided by the external power source connected to the power connecting terminal for jumpstarting 300 may be passed through the junction box 400 and provided to the auxiliary battery 100. Thus, the auxiliary battery 100 may be charged by the electric energy.

Then, the controller 200 monitors the voltage of the auxiliary battery 100, and when the voltage value is above a threshold value, the controller 200 determines that the auxiliary battery 100 is sufficiently charged to normally operate. Then, the controller 200 may turn off the second relay R2, electrically block the power connecting terminal for jumpstarting 300 and connecting the vehicle system, and disconnect the external power connected to power connecting terminal for jumpstarting 300.

Furthermore, the controller 200 may monitor an electric state of the terminal of the reconnection switch SW that is connected to the control unit to turn on the first relay R1.

The controller 200 may determine that the reconnection input signal to turn on the first relay R1 is received when an electric signal is applied to a line in which the reconnection switch SW and the control unit of the first relay R1 are connected. Also, when the reconnection input signal is maintained for a preset threshold time period or more, the controller 200 outputs a warning to inform that the reconnection switch SW is still in an ON state. Therefore, unnecessary energy consumption of the auxiliary battery 100 or external power may be prevented, and also, damage to the first relay R1 may be prevented.

As described above, various exemplary embodiments in the present disclosure may reconnect (turn on) the relay that mutually blocks the auxiliary battery and the vehicle system at any time when the jumpstarting is initiated. In particular, although the auxiliary battery is in an over-discharged state and the auxiliary battery is not capable of providing enough voltage to turn on the relay, the relay may be turned on by using the external power provided for jumpstarting.

By using these features, various exemplary embodiments in the present disclosure are capable of charging the auxiliary battery by using the external power, and over-charging of the auxiliary battery is also prevented by monitoring the voltage of the auxiliary battery through the controller.

In addition, when the reconnection switch is maintained in an ON state, the reconnection switch is used to turn on the relay that connects/blocks the auxiliary battery to the vehicle system, whereby various exemplary embodiments in the present disclosure detect the ON state and output a warning. Thus, unnecessary energy consumption and relay damage may be prevented.

Although exemplary embodiments in the present disclosure have been described for illustrative purposes, those skilled in the art will appreciate that various modifications, additions and substitutions are possible, without departing from the scope and spirit of the invention as disclosed in the accompanying claims.

What is claimed is:

1. A vehicle electrical power system for jumpstarting, the system comprising:
an auxiliary battery;
a first relay having a first end connected to the auxiliary battery;
a power connecting terminal for jumpstarting, the power connecting terminal being connected to an external power source when jumpstarting is initiated;
a second relay having a first end connected to the power connecting terminal and a second end electrically connected to a second end of the first relay; and
a reconnection switch having a first end connected both to the auxiliary battery and to the power connecting terminal and a second end connected to a control terminal used to turn on the first relay,
wherein the reconnection switch electrically connects the first and second ends thereof to each other in response to a reconnecting input signal, thereby applying external power received by the power connecting terminal to the control terminal, and turning on the first relay.

2. The system of claim 1, further comprising:
a controller for monitoring a voltage of the auxiliary battery, turning off the first relay, and turning on the second relay when the voltage of the auxiliary battery is less than or equal to a threshold value.

3. The system of claim 2, wherein the controller includes a power terminal electrically connected to the second end of the second relay, and the external power received by the power connecting terminal is input to the power terminal when the second relay is turned on.

4. The system of claim 2, wherein the controller monitors an electric state of the second end of the reconnection switch, and determines that the reconnecting input signal to turn on the first relay is received when an electrical signal is applied to the second end of the reconnection switch.

5. The system of claim 4, wherein the controller outputs a warning signal when the reconnecting input signal to turn on the first relay is maintained for a threshold time period or more.

6. The system of claim 3, further comprising:
a junction box forming an electric connection between the second end of the first relay, the second end of the second relay, and the power terminal of the controller.

7. The system of claim 1, wherein the first relay is turned on and the auxiliary battery is charged with the external power when the reconnecting input signal is applied to the reconnection switch in a state in which the second relay is turned on and the external power is applied to the power connecting terminal.
